(19) United States
(12) Patent Application Publication
(10) Pub. No.: US 2024/0308264 A1
(43) Pub. Date: Sep. 19, 2024

(54) SECURITY ELEMENT AND METHOD FOR PRODUCING SAME

(71) Applicant: GIESECKE+DEVRIENT CURRENCY TECHNOLOGY GMBH, Munchen (DE)

(72) Inventors: Winfried HOFFMULLER, Bad Tolz (DE); Christine HETTENKOFER, Aying (DE); Erwin BACHER, Hausham (DE); Patrick RENNER, Reichersbeuern (DE)

(21) Appl. No.: 18/546,836

(22) PCT Filed: Jan. 12, 2022
(86) PCT No.: PCT/EP2022/025012

§ 371 Date: Aug. 17, 2023

(30) Foreign Application Priority Data
Feb. 19, 2021 (DE) 10 2021 000 890.1

(51) Int. Cl. B42D 25/455; B42D 25/29; B42D 25/46; B42D 25/47; C09J 7/35; C09J 11/06

(52) U.S. Cl. CPC B42D 25/455; B42D 25/29; B42D 25/46; B42D 25/47; C09J 7/35; C09J 11/06; C09J 2203/338; C09J 2301/304; C09J 2433/00

(57) ABSTRACT

A security element for documents of value or the like, has a substrate which has been coated with a heat-sealing adhesive that is non-tacky at room temperature and suitable for applying the security element to a substrate of a document of value. The heat-sealing adhesive contains a radiation-crosslinkable component and a reactive diluent.

The invention relates to a security element for documents of value or the like, which has been coated with a heat-sealing adhesive that is non-tacky at room temperature and suitable for applying the security element to a substrate of a document of value. The invention also relates to a method for producing such a security element. Furthermore, the invention relates to a document of value having such a security element and to a method for producing the document of value provided with the security element.

Documents of value, in particular banknotes, are often equipped with security elements for security purposes, which allow the authenticity of the document of value to be checked and at the same time serve as protection against unauthorized reproduction. Documents of value within the meaning of the present invention are in particular banknotes, shares, identity cards, credit cards, bonds, certificates, vouchers, checks, high-value admission tickets, but also other papers at risk of forgery, such as passports and other identification documents, as well as product security elements such as labels, seals, packagings and the like. Hereinafter, the term “document of value” also includes the preliminary stage of a document of value, in particular a security paper, which is not yet capable of being put into circulation.

It is known to secure documents of value, for example banknotes, with a security element in the form of a security thread, a security strip or a patch or label.

In almost all security and banknote papers nowadays, a thread coated with heat-scaling adhesive, in particular heat-sealing lacquer, is introduced as a security thread into the paper on the paper machine. The heat-scaling lacquer serves to improve the anchoring of the thread in the paper. Heat-sealing lacquers are also used in banknote production for the application of holograms and hologram strips.

When applying security elements with the aid of heat-sealing lacquers, at least one of the substrates to be bonded is coated with a solvent-based polymer solution or an aqueous solution or dispersion. Physical drying by means of heating results in a surface that is non-tacky at room temperature. Under the action of temperature, the sealable mass melts and acts as an adhesive.

EP 1 776 240 B1 discloses the use of a heat-scaling adhesive that is non-tacky at room temperature for applying a security element to a substrate of a document of value by a heat scaling process at elevated pressure and elevated temperature. The heat-sealing adhesive also contains a component that can be crosslinked by high-energy radiation. The presence of the component that can be crosslinked by high-energy radiation within the heat-sealing adhesive makes it possible to carry out crosslinking by irradiation when applying the security element to the substrate of the document of value. This creates a high-melting to infusible system, which results in high stability and, in particular, pronounced hot water resistance. The hot water resistance can be determined, for example, using a washing machine. A suitable hot water test is performed in particular under the conditions 100° C./30 min or 60° C./1.5 h.

The heat-scaling adhesive known from EP 1 776 240 B1 can be applied in the form of a solution, an emulsion or in the form of a dispersion to the security element to be applied. The radiation-crosslinkable coating applied in this form melts at low temperatures and penetrates into the substrate of the document of value, which results in easy processability. The security elements coated in this way but not yet crosslinked can ideally be stored without a change in the melting point. For example, films provided with the coating that is non-tacky at room temperature can be wound up and stored over a relatively long period of time without a change in the melting point.

When applying the heat-sealing adhesive known from EP 1 776 240 B1 in the form of a solution, an emulsion or in the form of a dispersion to the security element to be applied, physical drying is necessary, which for example is effected by a slight increase in temperature to 80° C. In this way, any solvent and/or water present is driven out from the radiation-curable dispersion, solution or emulsion. Under some circumstances, the physical drying requires such intense application of heat that unintended curing occurs in the case of highly reactive adhesive systems. In the case of an adhesive system that is slow to react, an excessively short thermal exposure time during the application of the security element provided with heat-sealing adhesive to a substrate of a document of value would result in insufficient curing and thus in poor adhesion of the security element to the substrate of the document of value.

The object of the present invention is to provide a security element through which the disadvantages of the prior art are overcome.

This object is achieved by the combination of features defined in the main claim. Developments of the invention are the subject of the subclaims.

### SUMMARY OF THE INVENTION

1. (First aspect of the invention) A security element for documents of value or the like, having a substrate (1, 21) which has been coated with a heat-sealing adhesive (2, 22) that is non-tacky at room temperature and suitable for applying the security element to a substrate of a document of value, wherein the heat-sealing adhesive (2, 22) contains a radiation-crosslinkable component and a reactive diluent.

2. (Preferred configuration) The security element according to clause 1, wherein the reactive diluent is a low molecular weight compound having a molecular molar mass M<1000 g/mol and preferably is selected from TMP(EO)ₓTA and DPHA.

3. (Preferred configuration) The security element according to clause 1 or 2, wherein the heat-sealing adhesive (2, 22) additionally contains a plasticizer, which preferably has a melting point in a range from 50° C. to 120° C.

4. (Preferred configuration) The security element according to clause 3, wherein the plasticizer is selected from the group consisting of triphenyl phosphate, pentaerythritol tetrabenzoate, cyclohexanedimethanol dibenzoate, sucrose benzoate, and a mixture of two or more of the aforementioned elements.

5. (Preferred configuration) The security element according to clause 3 or 4, wherein the plasticizer is present in the heat-sealing adhesive (2, 22) in a proportion by weight in a range from 1% to 30%, preferably 2% to 10%, based on the solids.

6. (Preferred configuration) The security element according to any of clauses 1 to 5, wherein the heat-sealing adhesive (2, 22) that is non-tacky at room temperature and suitable for applying the security element to a substrate of a document of value is present in an at least physically dried state.

7. (Preferred configuration) The security element according to any of clauses 1 to 6, wherein the substrate (1, 21) is a flat substrate (1, 21) having two opposite main surfaces, wherein at least one main surface of the substrate (1, 21) is at least partly provided with the heat-sealing adhesive (2, 22) that is non-tacky at room temperature and suitable for applying the security element to a substrate of a document of value.

8. (Preferred configuration) The security element according to any of clauses 1 to 7, wherein the heat-sealing adhesive (2, 22) that is non-tacky at room temperature and suitable for applying the security element to a substrate of a document of value is obtainable by means of application of a solution, emulsion or dispersion.

9. (Preferred configuration) The security element according to clause 8, wherein the heat-sealing adhesive (2, 22) that is non-tacky at room temperature and suitable for applying the security element to a substrate of a document of value is obtainable by means of application of an aqueous dispersion.

10. (Preferred configuration) The security element according to clause 8, wherein the heat-sealing adhesive (2, 22) that is non-tacky at room temperature and suitable for applying the security element to a substrate of a document of value is obtainable by means of application of a solution based on an organic solvent, the organic solvent preferably comprising at least butyl acetate, propyl acetate or ethyl acetate, more preferably in a proportion by weight in a range from 30% to 90%, especially preferably 40% to 75%.

11. (Preferred configuration) The security element according to clause 10, wherein the heat-sealing adhesive (2, 22) additionally comprises a prepolymer that is non-tacky at room temperature after physical drying, contains on average at least two reactive groups and has a molecular weight of at least 600 g/mol, preferably in a proportion by weight in a range from 8% to 65%.

12. (Preferred configuration) The security element according to clause 9, wherein the dispersion is selected from the group consisting of aliphatic polyurethane dispersions, aromatic polyurethane dispersions, acrylates, anionic acrylate-modified polyurethane dispersions, polyurethane-polyether acrylates, and mixtures of two or more of the aforementioned elements.

13. (Preferred configuration) The security element according to any of clauses 1 to 12, wherein the heat-sealing adhesive (2, 22) comprises a cationically radiation-curing resin.

14. (Preferred configuration) The security element according to any of clauses 1 to 13, wherein the radiation-crosslinkable component is crosslinkable by ultraviolet radiation or electron radiation.

15. (Preferred configuration) The security element according to any of clauses 1 to 14, wherein the heat-sealing adhesive (2, 22) contains a photoinitiator.

16. (Preferred configuration) The security element according to any of clauses 1 to 15, wherein the substrate (1, 21) is a transparent plastics film, in particular a polyethylene terephthalate (PET) film.

17. (Second aspect of the invention) A document of value, in particular a banknote, comprising a security element according to any of clauses 1 to 16.

18. (Third aspect of the invention) A method for producing a security element according to any of clauses 1 to 16, comprising the step of applying to a substrate (1, 21) a heat-sealing adhesive (2, 22) that is non-tacky at room temperature and suitable for applying the security element to a substrate of a document of value, wherein the heat-sealing adhesive (2, 22) contains a radiation-crosslinkable component and a reactive diluent.

19. (Fourth aspect of the invention) A method for producing a document of value according to clause 17, comprising the step of equipping the substrate of the document of value, in particular a paper substrate, with the security element according to any of clauses 1 to 16.

20. (Preferred configuration) The method according to clause 19, wherein the security element is applied to the substrate (3) of the document of value at elevated pressure and elevated temperature and the heat-sealing adhesive (2, 22) that is non-tacky at room temperature is then at least precrosslinked by means of radiation.

### DETAILED DESCRIPTION OF THE INVENTION

The phrase “a heat-sealing adhesive that is tack-free at room temperature” or the phrase “a heat-sealing adhesive that is essentially tack-free at room temperature” is also used herein in place of the phrase “a heat-sealing adhesive that is non-tacky at room temperature”.

The term “room temperature” is understood herein to mean a temperature of 23° C.

The term “heat-sealing lacquer” is also used herein in place of the term “heat-sealing adhesive”.

The security element according to the invention is provided with a heat-sealing adhesive that is non-tacky at room temperature. The heat-sealing adhesive also has a radiation-crosslinkable component and a reactive diluent. The invention builds on the heat-sealing adhesive known from EP 1 776 240 B1. The invention is based on the finding that a reduction in the sealing temperature and at the same time improved wetting properties of the melt can be achieved if a reactive diluent is admixed with the heat-sealing adhesive composition. In particular in the case of aqueous formulations, particularly advantageous effects can be achieved if reactive diluent is present in addition to the actual, dispersed urethane acrylate component. Without being bound thereto, it can be assumed that the reactive diluents migrate into the dispersion particles in the first step and are less to be found in the aqueous phase. After physical drying, they function as coalescing agents and thus promote film formation. Depending on the formulation, complete freedom from tack, i.e. non-tacky behavior, can be guaranteed. An example of a dispersion that in its form as supplied already contains reactive diluents is Alberdingk Lux 481. In this case, less than 10% DPHA and 3% to 5% TMP (EO)ₓTA are present. The abbreviation “TMP(EO)TA” stands for trimethylolpropane (ethoxy) triacrylate, the abbreviation DPHA for dipentaerythritol hexaacrylate. Particularly good heat-scalable dispersions are achievable even with a content of less than 15% TMP(EO)ₓTA alone. In the formula TMP(EO)ₓTA, x is preferably in a range from 1 to 9, further preferably in a range from 3 to 9, with x particularly preferably being 3.

The heat-sealing lacquer formulations according to the invention are preferably aqueous dispersions and in particular those which contain 5% to 25%, preferably 9% to 16%, of a low molecular weight compound (M<1000 g/mol) either from the outset or after addition.

The advantages of reactive diluents are the general lowering of the sealing temperature and the improved wetting properties of the melt. A disadvantage is the reduction in blocking resistance. The use of multifunctional reactive diluents leads after crosslinking to a high molecular weight system that may no longer be fusible. A property that, although not detrimental, does not have to be sought either, provided that the melting point is only high enough that melting can no longer be used to detach a security element without destroying it.

It is expedient to admix triphenyl phosphate, pentaerythritol tetrabenzoate, cyclohex-anedimethanol dibenzoate and/or sucrose benzoate as a soluble component with the heat-sealing lacquer formulation according to the invention. This is a type of plasticizer with a preferred melting point in a range from 50° C. to 120° C. It is preferable for the plasticizer to be added in a proportion by weight of 1% to 30%, preferably 2% to 10% (based on the solids). These substances, which are solid at room temperature, are less critical than liquid substances with regard to the blocking behavior. Due to their solubility in reactive diluents, they can also be incorporated into the overall formulation.

Alternatively, if not proceeding on the basis of an aqueous dispersion, but rather on the basis of a UV system, such as is available as a dual-cure system, in particular a solvent-based formulation, in which case butyl acetate is preferably usable as solvent, the plasticizers mentioned above can also be dissolved directly, where after physical drying they are present in solid form again and have only little effect on blocking.

The heat-sealing lacquer formulation according to the invention comprises at least one solvent which is present in a preferred proportion by weight in a range from 30% to 90%, especially preferably in a range from 40% to 75%, the solvent preferably being selected from the group consisting of butyl acetate, propyl acetate, ethyl acetate, and a mixture of two or more of the aforementioned substances.

It is preferable to additionally admix a prepolymer which is tack-free at room temperature after physical drying, contains on average at least two reactive groups and has a molecular weight of at least 600 g/mol. The prepolymer is preferably present in the heat-sealing lacquer formulation in a proportion by weight in a range from 8% to 65%.

An amine synergist can be added to the heat-sealing lacquer formulation in order to increase the reactivity.

In the case of electron beam curing, no photoinitiator is required. In the case of an aqueous formulation in particular, the photoinitiators TPO-L, Omnirad 500 and Omnirad 819 DW are advantageous. The preferred proportion by weight is 1% to 8%, based on the respective solids. In addition, especially when using photoinitiators from the BAPO series, a sensitizer, for example from the ITX family, can be advantageous for higher reactivity. The abbreviation “BAPO” stands for phenylbis(2,4,6-trimethylbenzoyl)phosphine oxide, the abbreviation “ITX” stands for isopropylthioxanthone.

In some cases, the heat-sealing lacquer does not adhere directly to the security element to be adhesively bonded. In these cases, it is expedient to modify the security element, for example by using a print-pretreated film, or to pretreat it with known pretreatment methods, for example plasma or corona pretreatment, or to provide it with a primer.

When selecting suitable primers, it has been found that the potential of UV crosslinking of the heat-sealing lacquer can be fully exploited especially with reactive primer systems. These are for example two-component PU systems, which are applied in particular in multiple layers. It is particularly advantageous if at least one layer contains an aliphatic isocyanate.

The reactive diluents mentioned in regard to the aqueous systems and the soluble, low molecular weight constituents or plasticizers mentioned especially in regard to the solvent systems are capable of migration. As a result, when stored appropriately they can spread throughout the structure and the adhesion to the substrate is lost and the scalability deteriorates.

In the field of PVC films, it is common to use barrier layers against the migration of plasticizers. In this field, solvent-based coatings of relatively high molecular weight acrylates are used. Typical substances for this are available under the brand names Degalan and Elvacite.

According to a particular variant, a radiation-crosslinkable heat-sealing lacquer can be applied in two or more layers, with the first layer being able to be crosslinked beforehand. If on a primer the first layer of the heat-sealing lacquer is radiation-crosslinked after physical drying, the first layer itself can also serve as a barrier layer against migration-capable constituents of the following heat-sealing lacquer layers. It also prevents any spacers used, such as wax, from sinking into the heat-sealing lacquer or primer structure.

The crosslinking of the heat-sealing lacquer can take place directly after sealing, preferably still using the elevated temperature of the sealing process, since at this point the raw materials have not yet had the opportunity to undergo crystallization processes and hence the mobility of the reactive groups is better and hence the crosslinking is better. This is particularly advantageous in the case of crosslinking with medium-pressure mercury emitters, which themselves emit a lot of heat, and in the case of crosslinking with LED emitters, which emit little heat. If the heating from the emitters is not sufficient, a heating roller is expedient in order to be able to control the temperature before and during the crosslinking.

Should UV crosslinking not be possible in the application machine, UV crosslinking is also possible in a separate workstep. Preference is given to a workstep in which UV crosslinking is to be effected anyway. A typical example is crosslinking on a screen printing machine, which, if equipped accordingly, can irradiate a substrate from both sides. If the security element to be adhesively bonded is a patch, usually only part of the security element is provided with an opaque layer that impedes the crosslinking. The edge region is usually transparent. As a result, the edge region can be crosslinked very easily by exposure from above, while the regions beneath the opaque coating are preferably exposed from below, through the substrate. The opaque coating is often a metallization that reflects the corresponding light and thus enables better utilization of the light radiated through the substrate.

Heat-sealing lacquers in the uncrosslinked state have the property of softening under the action of temperature. In the case of intaglio printing, elevated temperatures and high pressure prevail. When using a high layer thickness of the heat-sealing lacquer, a strong embossing can thus also be achieved. If crosslinking is effected afterwards, the embossing can be permanently fixed. This is particularly advantageous for substrates that can be plastically deformed in intaglio printing.

Besides the advantage of high resistance, radiation-crosslinkable heat-sealing lacquers have the disadvantage that what is known as trough formation, that is to say poor flatness, is particularly pronounced after the crosslinking, since the system is one that shrinks during curing and after curing is a crosslinked system that is no longer flowable, and it is hardly possible to reduce stresses later on.

This can be achieved firstly by adding the plasticizers described above, which allow limited deformability even after crosslinking, and secondly by adding what are known as chain-transfer agents. These can for example be thiols. Chain-transfer agents shift the gel point to a later point in time within the context of a crosslinking reaction, which means that fewer stresses build up.

The uppermost layer of the security element, which is in contact with the heat-sealing lacquer, can for example be a conventional, unpretreated polyester film, but it can also be a coextruded film that has a layer with lower adhesion to the heat-sealing lacquer. Since, for example, in the case of a patch, a double film may also be present as the carrier, any film with lower adhesion to the adhesive can also be laminated on. A siliconized polyester film is also possible. A normal polyester film can also be additionally coated with a layer that has less of a tendency to blocking. This layer can also have larger spacers.

The photoinitiator used in the case of UV curing can, as a small, defined molecule, have a fixed melting point. If this is in the appropriate temperature range, it can promote melting behavior.

While the use of UV absorbers or stabilizers is customary in the case of aqueous dispersions for outdoor applications, it is customary only to use stabilizers in the case of hotmelts in order to enable longer temperature stability in the melt in the extruder or application apparatus.

If required, for example, benzotriazole-based UV absorbers such as Tinuvin 9945 DW and/or triazines such as Tinuvin 477 DW can be admixed as additives. An amount should be added such that the blocking resistance is not impaired. In order that the absorbers can develop their effect, the absorbers should be compatible with the film of the aqueous dispersion. At the same time, the absorbers are ideally liquid at room temperature or have a low melting point. It can therefore be expected that the addition of the absorbers can improve not only the weathering stability but also the scalability. The crosslinking should not be impaired in the long-wave UV region, that is to say at the border with the visible region, typically LED 395 nm.

In the case of a security strip to be applied to a substrate of a document of value, in particular a paper substrate, in particular in the case of a transfer element that is to be detached from a temporary carrier film, exposure can be effected after the application of the security strip from the side of the security strip through the carrier film, or after the carrier film has been pulled off, or from the side of the substrate of the document of value, depending on the transparency of the various elements.

In the case of a security strip with a permanent carrier film that is to be applied to a substrate of a document of value, the exposure can be effected after application of the security strip from the side of the security strip through the carrier film, or from the side of the substrate of the document of value, depending on the transparency of the various elements.

In the case of a patch or label to be applied to a substrate of a document of value, there are restrictions. In order to save on carrier film and to be able to produce more cost-effective patch elements, the patch elements are often arranged more closely on the carrier film than on the later substrate of the document of value. Therefore, exposure can be effected either only after the carrier film has been pulled off or using a mask that can rotate, for example, so that in each case only the patch that has already been applied is exposed and not the patch elements still on the carrier film, or in the case of an LED emitter the emitter is actuated in such a way that it only emits at the right moment for patch exposure and is then virtually switched off again. This aspect of patch exposure by rapidly switching the emitter on and off is advantageous since a substantial problem of LED emitters is the temperature. At high temperature, they lose output and service life. If the patch area to be irradiated is only approx. ⅓ of the total area, the heat development is then reduced by ⅔, as a result of which the emitter can under some circumstances even be operated with a higher output than its output in continuous operation and a saving is made at least on cooling capacity.

It may be expedient to print a primer underneath the security element to be applied to a substrate of a document of value. The primer can be made up on a similar basis to that of the heat-sealing lacquer that is to be used. When printing-on a primer, which first undergoes physical drying, better adhesion is usually achieved than with conventional heat sealing. If the primer and the heat-sealing lacquer have a similar basis, they bond optimally during heat-sealing and can inseparably polymerize together during subsequent irradiation. However, there may under some circumstances be the difficulty that the primer then also melts during the scaling operation and leads to fouling of the calender or backing roll, for which reason it is expedient in an attempt to implement only a narrower primer imprint than the security element to be sealed.

The heat-sealing lacquer according to the invention leads to an advantageous reduction in the required sealing temperature. If a system is present that, for example, has an additional primer or an additional ink receiving layer but is not optimized for a low melting point, it can also be printed over a relatively large area and still does not become deposited on rollers during the scaling operation. The process window can be extended by adding a non-stick coating to the relevant roller.

Consequently, the use of systems with different sealing properties as a precoating, at least in a subregion of the substrate, is just as conceivable as the use as a heat-sealing lacquer.

The coating according to the invention can be applied in the form of a solution, an emulsion or in the form of a dispersion. The radiation-crosslinkable coating applied in this form melts at low temperatures and penetrates into the substrate, which results in easy processability. The security element according to the invention is consequently provided with a low-melting system that, however, is essentially tack-free at room temperature. The presence of a radiation-crosslinkable component in the coating allows crosslinking to be carried out by irradiation after the coating has been applied. This creates a high-melting to infusible system, resulting in the achievement of high stability and, in particular, sufficient hot water resistance, for example in the washing machine test. A suitable hot water test is performed in particular at 100° C./30 min or 60° C./1.5 h.

During the crosslinking the adhesion to the substrate, for example a print-pretreated film, improves and the internal strength of the coating increases. The temperature of the coating prevailing immediately before, during and immediately after curing is an important parameter that determines the degree of crosslinking that can be achieved. A higher degree of crosslinking can be achieved at higher temperatures because the mobility of the reactive groups is higher.

The customary UV coatings are liquid before crosslinking and generate a considerable amount of heat of reaction, since there are many reactive groups in a small space. The radiation-curable and in particular UV-curable coatings according to the present invention, in contrast, consist of molecules with a relatively high molecular weight and are solid at room temperature. As a result of the lower number of reactive groups per unit of volume/mass, the heat of reaction is lower. As a result, the external input of heat plays a greater role in crosslinking. The mechanical properties of the coating can therefore be controlled via the temperature during curing.

The security elements coated in this way but not yet crosslinked can be stored without a change in the melting point. For example, films provided with the coating that is essentially tack-free at room temperature can be wound up and stored over a relatively long period of time without a change in the melting point.

According to an advantageous development of the invention, the coating that is essentially tack-free at room temperature is present in an at least physically dried state. Any solvent and/or water present is driven out from the radiation-curable dispersion, solution or emulsion by a slight increase in temperature to, for example, 80° C. This physical drying causes the coating to be essentially tack-free at room temperature.

In the context of the present description, the term “essentially tack-free” also means essentially nonadhesive in the sense of a smooth, essentially non-sticky surface. The check can be performed using the following test: Coated foil pieces of about 100 cm² are stacked and loaded with a weight of 10 kg and stored at 40° C. for 72 hours. If the pieces of film can thereafter be effortlessly separated from one another without damaging the coatings, the coating can be regarded as essentially tack-free.

The substrate of the security element according to the invention can in principle take any form. For example, the security element according to the invention can consist of fibers that have been provided with the coating that is essentially tack-free at room temperature. According to an advantageous variant of the invention, however, it is a flat substrate with two opposing main surfaces. Preferably, only one main surface of the substrate is provided with a coating that is essentially tack-free at room temperature.

It is in principle sufficient if a main surface of the substrate is partly provided with the coating that is essentially tack-free at room temperature. However, for optimal embedding of the security element in a security paper or in a document of value, it is expedient if the main surface(s) of the substrate is provided over the entire surface with the coating that is essentially tack-free at room temperature. Depending on the size of the security element, however, it may also be sufficient for only a subregion of the substrate to be provided with the coating that is essentially tack-free at room temperature.

If the security element is completely embedded in the security paper, it has proven to be particularly expedient if both main surfaces of the substrate are provided with the coating that is essentially tack-free at room temperature. This variant is used in particular when the security element is embedded in a security paper or document of value in the manner of a window security thread. The main surfaces can be provided either with coatings of the same type or with different coatings.

According to a further preferred embodiment of the present invention the security element has a thickness of 1 μm to 100 μm, preferably a thickness of 2 μm to 50 μm. These are the easily manageable thicknesses of the security elements when equipping documents of value and security papers with security elements.

The substrate of the security element according to the invention is preferably of multilayer and/or flexible design. The advantages associated with the multilayer nature of the security element are described in more detail hereinafter. Flexibility of the security element is often desirable, since the documents of value equipped with the security element, such as banknotes or certificates, are generally also flexible.

The coating that is essentially tack-free at room temperature is preferably applied to the substrate as a solution, emulsion or dispersion and then physically dried. An aqueous dispersion is particularly preferably used.

Such an aqueous dispersion can be applied directly to a substrate, to a correspondingly print-pretreated or primed, i.e. primer-provided, film (for example Hostaphan RNK 2600, Mitsubishi Polyester Film) or, in cases in which there are further layers present between the substrate and the coating that is essentially tack-free at room temperature, can be applied to these. The film thus obtained can be wound up, transported and stored. The film can be applied to paper, to a further film or to a polymer by pressure and temperature (approx. 100° C. to 160° C.).

According to a further preferred embodiment of the present invention the dispersion is selected from the group consisting of aliphatic polyurethane dispersions, aromatic polyurethane dispersions, acrylates, anionic acrylate-modified polyurethane dispersions, polyurethane-polyether acrylates, and mixtures thereof.

Acrylated polyurethane dispersions are particularly suitable. Examples of such acrylated polyurethane dispersions that may be mentioned are DW7770, DW7773, DW7825, DW7772, DW7849 (UCB, Surface Specialties) and Actilane 340 epoxy novolac acrylate in butoxyethyl acctate (Akzo).

Examples of further radiation-curable dispersions are NeoRad R-440 (NeoResins), NeoRad R-441 (NeoResins), NeoRad R-445 (NeoResins), Laromer LR 8949 (BASF), Laromer LR 8983 (BASF), Laromer LR 9005 (BASF), LUX 101 UV dispersion (Alberdingk), LUX 241 UV dispersion (Alberdingk), LUX 308 UV dispersion (Alberdingk), LUX 352 UV dispersion (Alberdingk), LUX 370 UV dispersion (Alberdingk), LUX 390 UV dispersion (Alberdingk), LUX 399 UV dispersion (Alberdingk), LUX 331 UV dispersion (Alberdingk), LUX 338 UV dispersion (Alberdingk), Halwedrol UV 95/92 W (Hüttenes-Albertus), Halwedrol UV 14/40 W (Hüttenes-Albertus), Halwedrol UV-TN 6711/40 W (Hüttenes-Albertus), Halwedrol UV 65/40 W (Hüttenes-Albertus), Halwedrol UV-TN 7561-3/40 W (Hüttenes-Albertus), Halwedrol UV-TN 7157/40 W (Hüttenes-Albertus) and Bayhydrol UV VP LS 2280 (Bayer).

The dispersions mentioned include anionic and nonionic dispersions. Most of these dispersions are aliphatic polyurethane dispersions (for example aliphatic polyester polyurethanes), but there are also aromatic polyurethane dispersions and copolymers (for example dispersions based on aliphatic polyurethane and acrylic ester copolymers), acrylates (acrylic ester copolymers) and anionic acrylate-modified UV-curing polyurethane dispersions or also polyurethane-polyether acrylates.

The solids content of the dispersion is preferably between 30% by weight and 60% by weight, with preference between 35% by weight and 50% by weight. However, the solids content can be adjusted as required by dilution.

Commercial dispersions have a solids content of between 38% by weight and 51% by weight. Such dispersions are preferred in the context of the present invention because they are readily available.

The radiation-crosslinkable component present in the coating can preferably be crosslinked by ultraviolet radiation or by electron radiation. In terms of the spectral range, iron-doped emitters are particularly well suited. Alternatively, emitters using undoped mercury or emitters with gallium doping can be used. However, when curing through elements to be applied, Hg emitters have a somewhat less favorable spectral range, while Ga emitters bring about poorer surface curing.

According to a preferred embodiment, the coating that is essentially tack-free at room temperature contains a photoinitiator. Crosslinking can be initiated and controlled in a particularly simple manner using a photoinitiator. Preferred examples of such photoinitiators are Darocur 4265 (Ciba), Darocur 1173 (Ciba), Irgacure 500 (Ciba), Irgacure 184 (Ciba), Esacure KIP 100 F (Lamberti) and Irgacure 2959 (Ciba).

Particularly preferably, the photoinitiator is a water-soluble photoinitiator, a water-dispersible photoinitiator, or a photoinitiator that is soluble in water by means of water-compatible solvents. As an example of a water-soluble initiator, mention is made of Irgacure 2959 (Ciba). An example of a water-dispersible (or pre-dispersed) initiator is Irgacure 819 DW (Ciba). Mention is made by way of example of Lucirin TPO (BASF) as an initiator that is soluble in water with the aid of further water-compatible solvents.

In the case of water-miscible solvents, an increased VOC content may have to be accepted during processing, since the finished dispersion should contain a proportion of solvent that prevents the photoinitiators used from precipitating out. If this is not possible, rheology additives (anti-settling additives) must be used. In this way it is possible to avoid having to stir up the dispersion again before each use.

According to a further preferred embodiment of the present invention, the coating that is essentially tack-free at room temperature is present as a cationically radiation-curing resin. Epoxy-modified vinyl copolymers are particularly well suited. As an example of such epoxy-modified vinyl copolymers, mention can be made of UCAR VERR-40 (The Dow Chemical Company).

The radiation-crosslinkable component present in the tack-free coating can preferably be crosslinked by short-wave radiation, such as ultraviolet radiation or short-wave visible radiation, or by electron radiation. Particularly preferably, the radiation source used can be standard UV emitters (doped or undoped) or UV light-emitting diodes.

The tack-free coating comprising the cationically radiation-curing resin preferably contains a photoinitiator suitable for cationic radiation curing. With the aid thereof, the crosslinking can be initiated in a particularly simple manner. Optionally, the cationically radiation-curing resin can also be combined with further resins. The coating comprising the cationically curing resin can further also be crosslinked only purely thermally. In this case, the use of a photoinitiator can be dispensed with.

In addition to the coating that is essentially tack-free at room temperature, the security element preferably comprises at least one further layer, this being a layer that has been at least precrosslinked by means of radiation. This layer is preferably applied between the substrate and the coating that is essentially tack-free at room temperature. This layer can be crosslinked by means of radiation to such an extent that later melting, which is associated with the risk of loss of adhesion due to dewetting, is ruled out, but good overprintability is nevertheless still ensured. To produce a security element according to the invention, the additional layer that has been at least precrosslinked by means of radiation is overcoated with the coating according to the invention, in particular with a UV-curable dispersion. This further layer is then merely dried physically to achieve tack-free properties while maintaining meltability.

In order to increase protection against forgery, the security element preferably additionally also comprises at least one security feature that can be checked visually and/or by machine.

According to a preferred configuration, the security feature that can be checked visually and/or by machine can include an optically variable effect, in particular a diffraction pattern, a hologram, a color-shift effect or other interference effects. According to another preferred configuration, the security element is provided with a printed image, in particular with positive or negative patterns or positive or negative symbols, as a security feature. As a further security feature, the security element can also contain fluorescent substances, phosphorescent substances and/or magnetic substances, which can be present in particular in the substrate. It goes without saying that combinations of such security features are also possible.

Preferably used as the substrate of the security element according to the invention is a transparent plastics film. Such films have the advantage that irradiation with UV light through the film can be carried out. For example, a PET film is transparent starting from the visible region in the UV region up to approx. 310 nm. Commercial UV emitters can therefore be used for irradiation. Alternatively, however, the substrate can also, optionally additionally, comprise a paper layer.

Particularly preferably, in addition to the substrate and the coating that is essentially tack-free at room temperature, the security element comprises at least one further layer, this being a layer that is reflective at least in regions.

Also preferred are embodiments in which, in addition to the substrate and the coating that is essentially tack-free at room temperature, the security element comprises at least one further layer, this being a layer in which is embossed a diffraction structure in the form of a relief. The diffraction structure is preferably provided with a reflective layer at least in regions.

The coating that is essentially tack-free at room temperature can also be used as an embossing lacquer. Customary thermoplastic embossing lacquers either require high temperatures and pressures during embossing or become cloudy or matt when the hologram is applied to a substrate, since the embossed structures soften and are compressed under application conditions. In the case of customary, generally liquid UV lacquer systems, on the other hand, only uniform curing of the embossed layer is possible, as a result of which a sharp-edged breaking-out during the production of a patch is possible only to a limited extent, if at all.

If a security element according to the invention with a coating that is essentially tack-free at room temperature is used on a substrate, in particular a plastics film, that has optionally been provided with a release layer (for example wax), a low-melting thermoplastic embossing lacquer is initially present. A motif, in particular a diffraction structure in the form of a relief, can be embossed into this lacquer layer. During this time or afterwards (also possibly after winding if the dispersion is configured to be non-blocking and has an appropriate glass transition point), the dispersion is cured by mask exposure. This means that the regions (patches) to be transferred later are exposed, but the intervening regions are not. The intervening regions therefore remain soft and fusible, as a result of which subsequent sharp-edged melting-out becomes possible, while the exposed regions remain hard and retain their embossed structures even during the transfer process. The coatings according to the present invention that are essentially tack-free at room temperature can therefore be crosslinked during the embossing process and are therefore dimensionally stable and brilliant even at high pressures and temperatures.

According to a preferred embodiment of the present invention, in addition to the substrate, the security element therefore comprises a coating that is essentially tack-free at room temperature, with a diffraction structure in the form of a relief being embossed into the coating that is essentially tack-free at room temperature. The coating that is essentially tack-free at room temperature is advantageously present in a form cured in regions. The coating that is essentially tack-free at room temperature is preferably provided with the diffraction structure only in the cured regions.

Advantageously, at least the regions of the cured layer that are provided with the diffraction structure are equipped at least in regions with a reflective layer. The reflective layer is preferably present in the form of positive or negative patterns.

Security elements that are prepared on a separate layer, for example a plastics film, in the reverse order in which they will later come to lie on the security paper and are then transferred to the security paper in the desired outline forms using an adhesive layer or lacquer layer, are referred to as transfer elements. In this case, the separate layer can be pulled off from the layer structure of the security element after the transfer. In order to facilitate the detachment of the separate layer after the transfer of the security element, a release layer can be provided between this layer and the part of the security element to be detached.

According to a further preferred embodiment, in addition to the substrate and the coating that is essentially tack-free at room temperature, the security element therefore comprises at least one further layer, this being a release layer. It is particularly preferable for the release layer to be arranged between the substrate and the coating that is essentially tack-free at room temperature.

According to a further preferred embodiment, the coating of the security element that is essentially tack-free at room temperature is present in a form printed with printing ink and crosslinked by means of radiation. Paper coatings in particular should be dirt-repellent, offer good printing ink adhesion and not act as a separation point between paper and printing ink in durability tests. By using a defined temperature at which the crosslinking reaction of the coating that is essentially tack-free at room temperature is effected, the degree of crosslinking can be controlled and thus the balance between printing ink adhesion and dirt repellency can be adjusted.

Alternatively, printing can be effected either after the tack-free coating has fully crosslinked or before crosslinking. If printing is effected before crosslinking, the coating that is essentially tack-free at room temperature is printed, with the coating undergoing a kind of surface dissolution by the printing ink. The printing ink bonds to the coating, further improving adhesion. Rheology additives (especially thickeners) can be used to avoid problems caused by penetration or excessive absorption of the coating through/by the paper during application.

In a likewise advantageous variant, the tack-free coating is precrosslinked before printing with printing ink. However, complete crosslinking is effected here only after printing.

In preferred configurations, the security element is in the form of a security tape, a security strip, a patch or another flat security element.

The substrate of the security element can also be in the form of fibers, with the fibers being surrounded by the coating that is essentially tack-free at room temperature.

There are particular advantages when the security element is arranged over a window present in a security paper or an article of value. This window is preferably produced by papermaking techniques or punched out.

The present invention also encompasses a security paper for the production of security documents or documents of value, such as banknotes, checks, identity cards, certificates or the like, which is equipped with an above-described security element. Advantageously, in addition to the security element according to the invention, the security paper comprises at least one additional carrier substrate. A preferred carrier substrate is paper. The present invention likewise encompasses an article of value, branded article, document of value or the like having such a security element.

The security element can preferably be attached to the security paper or document of value or embedded within it. Alternatively, the security element is embedded in the security paper or document of value in the manner of a window security thread and is visible on the surface of the security paper or document of value in window regions thereof. The security element can also form a pendulating security thread that appears alternately on opposite surfaces of the security paper or document of value.

In the method for producing one of the security elements described above, a coating that is essentially tack-free at room temperature is at least partly applied to a substrate. The coating that is essentially tack-free at room temperature is then preferably at least physically dried.

According to a particularly preferred variant of the method, the coating that is essentially tack-free at room temperature is applied as an aqueous dispersion.

According to a further preferred variant of the method, the applied coating that is essentially tack-free at room temperature is a cationically radiation-curing resin.

In a preferred configuration of the method, at least one further layer is applied to the substrate at least in regions before the application of the coating that is essentially tack-free at room temperature. This further layer can be a radiation-crosslinkable layer, which is at least precrosslinked by means of radiation before the tack-free coating is applied. Precrosslinking can minimize later melting, which is associated with the risk of loss of adhesion to the substrate.

In a likewise advantageous variant, the coating that is essentially tack-free at room temperature is crosslinked by ultraviolet radiation or by electron radiation.

The present invention also encompasses a method for producing an above-described security paper or article of value, wherein the security paper or article of value is equipped with an above-described security element.

According to a preferred variant of the method, the security element is applied to a carrier substrate at elevated pressure and elevated temperature and the coating that is essentially non-tacky at room temperature is then at least precrosslinked by means of radiation. If the security element is present as a transfer element, the coating that is essentially tack-free at room temperature can be completely crosslinked after removal of the substrate and, if present, the release layer.

According to a further preferred variant of the method, the coating that is essentially tack-free at room temperature is irradiated from the direction of the coating with short-wave radiation, in particular short-wave visible radiation or UV radiation, immediately before application of the security element to the security paper or the article of value, and then applied to a carrier substrate at elevated pressure and elevated temperature. Exposure from the coating side is advantageous, since exposure of the carrier substrate to UV radiation and UV exposure of the material of the security element are avoided or at least significantly reduced.

The present invention also encompasses the use of one of the security elements described above for the production of film composite banknotes and the use as packaging material. For example, sterilizable film packagings can be sealed and crosslinked with a security element according to the invention. Successful UV sterilization is simultaneously accompanied by the sealing seam being crosslinked and becoming solid.

Further exemplary embodiments and advantages of the invention are elucidated hereinafter with reference to the figures. For the sake of better clarity, the figures are not presented true to scale or true to proportion.

In the figures,

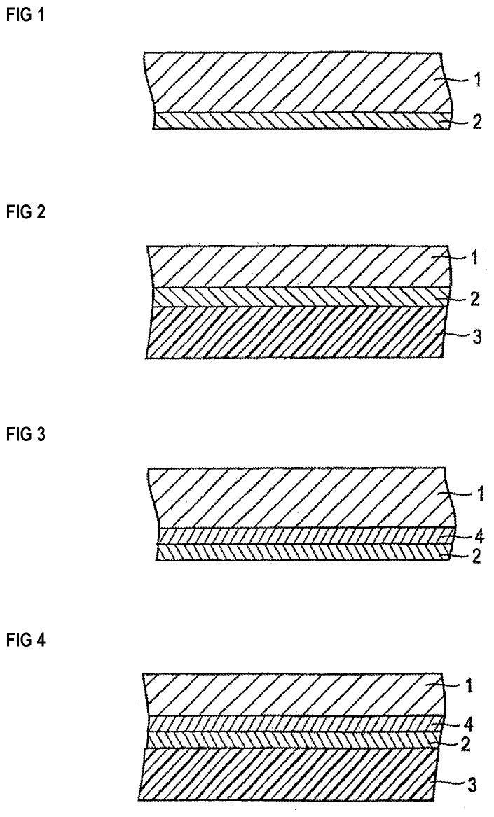

FIG. 1 shows in cross section a schematic illustration of a security element according to the invention with a coating that is essentially tack-free at room temperature;

FIG. 2 shows in cross section a schematic illustration of a security paper which is equipped with the security element from FIG. 1;

FIG. 3 shows a schematic illustration of a security element according to another exemplary embodiment of the invention in cross section;

FIG. 4 shows in cross section a schematic illustration of a security paper which is equipped with the security element from FIG. 3;

FIG. 5 shows a schematic illustration of a security paper according to another exemplary embodiment of the invention in cross section;

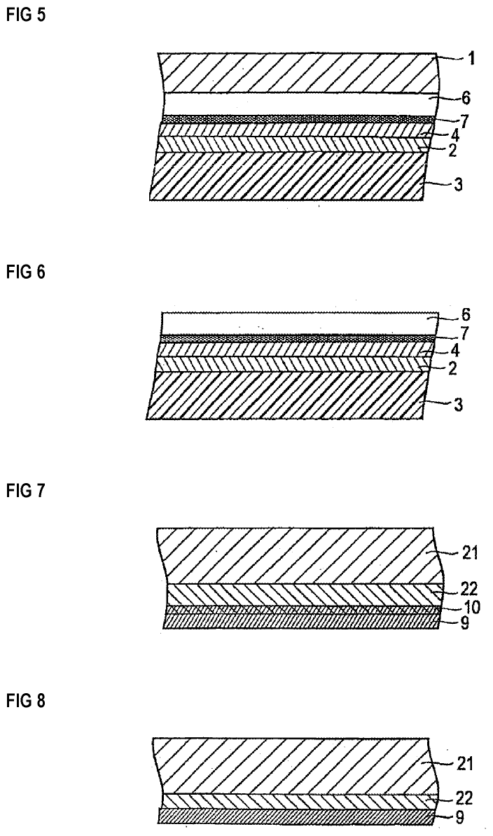

FIG. 6 shows in cross section a schematic illustration of the security paper from FIG. 5 after the detachment of the substrate of the security element configured as a transfer element;

FIG. 7 shows a schematic illustration of a security element or a security paper according to another exemplary embodiment of the invention in cross section;

FIG. 8 shows a schematic illustration of a security element or a security paper according to another exemplary embodiment of the invention in cross section;

FIG. 9 shows a schematic illustration of a security element configured as a transfer element according to another exemplary embodiment of the invention in cross section;

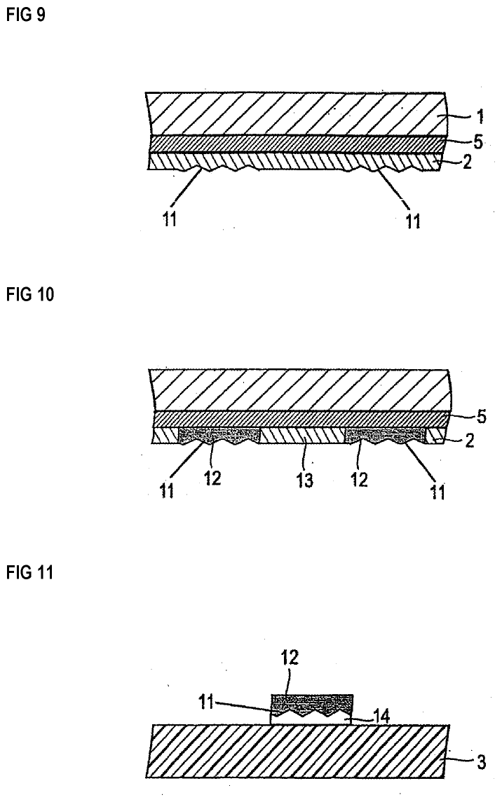

FIG. 10 shows a schematic illustration of the security element from FIG. 9 in cross section after exposure to UV radiation;

FIG. 11 shows a schematic illustration of a security paper according to another exemplary embodiment of the invention in cross section;

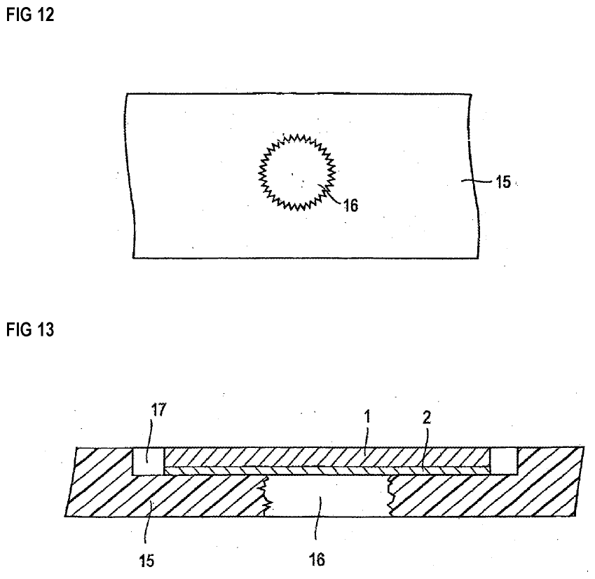

FIG. 12 shows a schematic illustration of a document of value in a top view;

FIG. 13 shows a cross section through the document of value from FIG. 12.

FIG. 1 shows a schematic illustration of a security element according to the invention with a substrate 1 and a coating 2 that is essentially tack-free at room temperature. To produce the security element, for example, a UV radiation-curable dispersion (UV dispersion) is applied to the substrate 1, for example to a plastics film, in particular a PET or OPP film. The UV dispersion is dried (for example at 80° C.), resulting in a coating 2 that is essentially tack-free at room temperature.

The security element and all security elements described hereinafter can be equipped with further security features (not illustrated in the respective figures), for example a hologram or a printed design.

FIG. 2 shows in cross section a schematic illustration of a security paper which is equipped with the security element from FIG. 1. To produce the security paper, the security element from FIG. 1 is transferred to a carrier substrate 3, for example paper, by a heat-sealing operation at elevated pressure and elevated temperature (for example at 140° C.). The coating that is essentially tack-free at room temperature therefore in this case takes on the function of a heat-sealing lacquer.

The coating 2 of FIG. 1 is then crosslinked by the action of UV radiation (for example Hg and Fe emitters), so as to ultimately obtain a security paper with a radiation-crosslinked, infusible coating 2 and a covering substrate 1, for example a plastics film.

FIG. 3 shows in cross section a schematic illustration of a security element according to another exemplary embodiment of the invention. To produce the security element, a UV dispersion is applied to a substrate 1, for example to a plastics film. The plastics film is, for example, a PET or OPP film. The UV dispersion is dried (for example at 80° C.) and crosslinked by the action of UV radiation, resulting in the formation of an infusible coating 4. A further coating with a UV dispersion is applied over this coating 4 and dried (for example at 80° C.), resulting in a coating 2 that is essentially tack-free at room temperature. The formation of such a two-layer coating has the advantage that good adhesion to the substrate 1 is ensured during the subsequent heat-scaling operation.

FIG. 4 shows in cross section a schematic illustration of a security paper which is equipped with the security element from FIG. 3. To produce the security paper, the security element from FIG. 3 is applied to a carrier substrate 3 made of paper by a heat-sealing operation at elevated pressure and elevated temperature (for example at 140° C.). The coating 2 of FIG. 3 is then crosslinked by the action of UV radiation (for example Hg and Fe emitters), so as to ultimately obtain a security paper with a two-layer, radiation-crosslinked, infusible coating 2, 4 and a covering substrate 1, here a plastics film.

The security elements described feature outstanding adhesion of the coatings 2, 4 to the substrate 1. This adhesion is not lost even at the elevated temperatures of the heat sealing operation. Should adhesion problems still arise with one of the plastics films used, a print-pretreated film (for example Hostaphan RNK2600, Mitsubishi Polyester Film) can for example be used.

FIG. 5 shows in cross section a schematic illustration of a security paper according to another exemplary embodiment of the invention. To produce the security element, configured here as a transfer element, with which the security paper shown in FIG. 5 is furnished, an embossing lacquer 6 is applied to a substrate 1, for example to a PET carrier film. Optionally, a release layer, for example made of wax, can be applied between the PET carrier film and the embossing lacquer layer 6. The embossing lacquer 6 is provided with a reflective layer 7, for example a metal layer or a high-refractive-index layer. All metals and many metal alloys can be considered as reflective materials. Examples of suitable high-refractive-index materials are CaS, CrO₂, ZnS. TiO₂ or SiOₓ. The reflective layer 7 can also be applied in the form of patterns or symbols, in particular positive or negative patterns. The embossing of the embossing lacquer 6, for example a diffraction structure in the form of a relief, which is not shown here for reasons of clarity and is present on the side of the embossing lacquer 6 facing away from the substrate 1, can be effected before or after the application of the reflective layer 7.

A UV dispersion is applied over the reflective layer 7 and thermally dried (for example at 80° C.), resulting in a coating 4 that is essentially tack-free at room temperature. The coating that is essentially tack-free at room temperature can in this case therefore serve as a protective lacquer for the metallization. If required, a primer/adhesion promoter layer can further be applied between the reflective layer 7 and the coating 4.

The UV dispersion is crosslinked by UV irradiation from the direction of the coating, i.e. from the side of the security paper that is essentially transparent to UV radiation, resulting in the formation of an infusible coating 4. A further coating with a UV-curable dispersion is then applied to this crosslinked UV dispersion layer and thermally dried (for example at 80° C.). The drying of the UV dispersion produces a coating 2 that is essentially tack-free at room temperature.

This security element is then applied to a carrier substrate 3 made of paper by a heat-scaling operation at elevated pressure and elevated temperature (for example at 140° C.) in order to produce the security paper illustrated. The coating 2 can then be precrosslinked through the PET carrier film by the action of UV radiation (for example Hg and Fe emitters), although precrosslinking is not absolutely necessary.

The PET carrier film and, if present, the release layer are then pulled off. However, the PET carrier film can also remain on the embossing lacquer layer 6 as a protective layer. In this case, no release layer is provided. Finally, the precrosslinked coating 2 is crosslinked through the reflective layer 7 by the action of UV radiation (for example Hg undoped emitter), so as to ultimately obtain the security paper shown schematically in cross section in FIG. 6 and having a carrier substrate 3 made of paper, a two-layer, radiation-crosslinked, infusible coating 2, 4, a reflective layer 7 and an embossing lacquer layer 6.

Crosslinking through a metal layer with the aid of UV radiation does not pose a technical problem because metallizations (especially aluminum) have a relatively high transparency, especially in the UV region. A metallization with aluminum (optical density=2.0), for example, is 5% to 10% transparent to radiation in the long-wave UV region. In addition, the embossing lacquer layer 6 in combination with the metal layer brings about a very good exclusion of oxygen, which leads to improved UV crosslinking of the coatings 2, 4.

FIG. 7 shows in cross section a schematic illustration of a security element or a security paper according to another exemplary embodiment of the invention. To produce the security element or paper, a UV dispersion is applied to the entire surface of a substrate 21 made of paper. The UV dispersion can also be applied to both sides of the substrate 21, so that the substrate 21 is completely surrounded by the coating 22, this not being illustrated here for reasons of clarity. If required, the UV dispersion can also contain rheology additives. The UV dispersion is dried (for example at 80° C.), resulting in a coating 22 that is essentially tack-free at room temperature. The essentially tack-free coating 22 is then printed with a printing ink 9.

As a result, the UV-curable coating 22 in the upper region 10 facing away from the paper substrate undergoes “surface dissolution”, i.e. the printing ink bonds with the coating 22. The coating 22 is then crosslinked by the action of UV radiation (for example Hg and Fe emitters), so as to obtain a security element or paper according to the invention and having a paper layer, a now radiation-crosslinked, infusible coating 22 which is printed with the printing ink 9.

Alternatively, to produce the security element or paper illustrated schematically in cross section in FIG. 8 according to another exemplary embodiment of the invention, a UV dispersion is applied to the entire surface of a substrate 21 made of paper. Here too, the UV dispersion can be applied to both sides of the substrate 21. The UV dispersion is dried (for example at 80° C.), resulting in a coating 22 that is essentially tack-free at room temperature. The coating 22 is then crosslinked by the action of UV radiation (for example Hg and Fe emitters), so as to obtain a security element or paper according to the invention and having a radiation-crosslinked, infusible coating 22. The radiation-crosslinked coating 22 can then be printed with printing ink 9, where the printing ink adhesion and the dirt-repellent properties can be adjusted via the degree of crosslinking of the coating 22.

FIG. 9 shows in cross section a schematic illustration of a security element configured as a transfer element according to another exemplary embodiment of the invention. To produce the security element, a coating with a UV dispersion is applied to a substrate 1, for example to a PET carrier film. The UV dispersion is thermally dried (for example at 80° C.), resulting in a coating 2 that is essentially tack-free at room temperature. Optionally, a release layer 5 can be applied between the PET carrier film and the coating 2.

A diffraction structure 11 can be embossed into the coating 2. In this case, the UV-curable dispersion is thus used as an embossing lacquer. During this operation or following it, the coating 2 is cured by the action of UV radiation. The exposure is performed through a mask. As can be seen from FIG. 10, the UV exposure is performed only at the locations 12 at which a motif in the form of a diffraction structure 11 has been embossed beforehand. In this way, the patches to be transferred in a subsequent step are exposed, but the regions lying therebetween are not. The intervening regions 13 therefore remain soft and fusible, as a result of which sharp-edged melting-out becomes possible during the transfer of the security element to a carrier substrate. The exposed regions 12, in contrast, remain hard even during the transfer process and their embossed structures are preserved. Optionally, the coating 2 including the diffraction structures 11 or else only the regions provided with a diffraction structure can be provided with a metal layer or a high-refractive-index layer, this not being illustrated here for reasons of clarity. The metal layer or high-refractive-index layer can further be applied in the form of patterns or symbols, in particular positive or negative patterns.

FIG. 11 shows in cross section a schematic illustration of a security paper which is equipped with the security element from FIG. 10. After the crosslinking of the coating 2, illustrated in FIG. 10 and brought about by UV exposure, at the locations 12 of the coating 2 at which a motif in the form of a diffraction structure 11 was embossed beforehand and, and possibly after the application of a metal layer or a high-refractive-index layer, the patch is applied to a carrier substrate 3 by means of a heat-sealing adhesive 14. As a result of the UV exposure that is limited to the locations 12, the intervening regions 13 remain soft and fusible, as a result of which sharp-edged melting-out becomes possible during the transfer of the security element by means of a hot punch. The exposed regions 12, in contrast, remain hard even during the transfer process and their embossed structures are preserved.

However, it is also possible to use a coating of UV-crosslinkable dispersion instead of the heat-sealing adhesive. However, it should be noted that the UV-crosslinkable dispersion is not transferred and crosslinked by means of UV radiation until after the non-cured intervening regions 13 have been removed.

FIG. 12 shows in a top view a document of value 15, for example a banknote, which is equipped with a through-opening 16. The opening 16 is preferably produced by papermaking techniques or is punched out. The production of such window openings 16 by machine is described in DE 101 63 381 A1.

FIG. 13 shows a cross section through the document of value 15 illustrated in FIG. 12, with the difference that the opening 16 has been closed by a security element according to the invention. The security element has a substrate 1 and a coating 2 that is essentially tack-free at room temperature.

The security element is preferably arranged in a depression 17 which surrounds the opening 16. The depression 17 can be produced by subsequent calendering of the paper web, i.e. by compressing the paper fibers. Alternatively, the depression 17 can also be produced by actually reducing the paper thickness in this region. The easiest way to do this is directly during the production of the paper web, by designing the sheet formation in this area to be thinner through a corresponding configuration of the mesh.

In a further exemplary embodiment (not illustrated), the security element consists of a substrate and a coating that is essentially tack-free at room temperature. To produce the security element, for example, a cationically radiation-curing resin, in particular an epoxy-modified vinyl copolymer (for example UCAR VERR-40, The Dow Chemical Company), provided with a photoinitiator suitable for cationic radiation curing, is applied to the substrate, for example to a plastics film, in particular a PET or OPP film. The cationically radiation-curing resin is dried (for example at 80° C.), resulting in a coating that is essentially tack-free at room temperature.

To produce a security paper equipped with the security element described above, the security element is transferred to a carrier substrate, for example paper, by a heat-sealing operation at elevated pressure and elevated temperature (for example at 140° C.). In this case the thermal crosslinking is already initiated. The cationically radiation-curable coating is then crosslinked by the action of UV radiation (for example Hg and Fe emitters), so as to ultimately obtain a security paper with a radiation-crosslinked, infusible coating and a covering substrate, for example a plastics film.

Alternatively, the coating can also be crosslinked only purely thermally. To this end, the security element is transferred to a carrier substrate, for example paper, only by a heat-sealing operation at elevated pressure and elevated temperature (for example at 140° C. to 160° C.). The thermal crosslinking is effected as part of the heat-sealing operation. It goes without saying that the use of a photoinitiator can be dispensed with in this method variant.

In contrast to free-radical radiation curing, cationic radiation curing is a slower process that continues even after the end of the irradiation. Whereas radicals are quickly scavenged, in cationic radiation curing an acid is liberated that catalyzes the crosslinking reaction in the coating. Therefore, in a further variant of the above exemplary embodiment, the cationically radiation-curable coating can be exposed to short-wave radiation (UV or short-wave blue radiation) from the coating side immediately before the application of the security element. The radiation source used can be either customary UV emitters (doped or undoped) or, preferably, UV light-emitting diodes. Besides positive safety-related aspects, UV light-emitting diodes also have technical advantages, since there is less heat input and less energy consumption. Exposure from the coating side is advantageous since there is no exposure of the carrier substrate, for example paper, to UV radiation and there is a lower UV exposure of the material of the security element. The crosslinking reaction is initiated by the exposure. At the time of application to the carrier substrate, due to the short period of time this reaction has not progressed to the extent that the melting of the coating would be impeded. However, since the reaction continues on its own without further measures, the security paper provided with the security element exhibits the required stabilities.

1.-20. (canceled)

21. A security element for documents of value or the like, having a substrate which has been coated with a heat-sealing adhesive that is non-tacky at room temperature and suitable for applying the security element to a substrate of a document of value,
wherein the heat-sealing adhesive contains a radiation-crosslinkable component and a reactive diluent.

22. The security element according to claim 21, wherein the reactive diluent is a low molecular weight compound having a molecular molar mass M<1000 g/mol and is selected from TMP(EO)ₓTA and DPHA.

23. The security element according to claim 21, wherein the heat-sealing adhesive additionally contains a plasticizer, which has a melting point in a range from 50° C. to 120° C.

24. The security element according to claim 23, wherein the plasticizer is selected from the group consisting of triphenyl phosphate, pentaerythritol tetrabenzoate, cyclohex-anedimethanol dibenzoate, sucrose benzoate, and a mixture of two or more of the aforementioned elements.

25. The security element according to claim 23, wherein the plasticizer is present in the heat-sealing adhesive in a proportion by weight in a range from 1% to 30% based on the solids.

26. The security element according to claim 21, wherein the heat-sealing adhesive that is non-tacky at room temperature and suitable for applying the security element to a substrate of a document of value is present in an at least physically dried state.

27. The security element according to claim 21, wherein the substrate is a flat substrate having two opposite main surfaces,
wherein at least one main surface of the substrate is at least partly provided with the heat-sealing adhesive that is non-tacky at room temperature and suitable for applying the security element to a substrate of a document of value.

28. The security element according to claim 21, wherein the heat-sealing adhesive that is non-tacky at room temperature and suitable for applying the security element to a substrate of a document of value is obtainable by means of application of a solution, emulsion or dispersion.

29. The security element according to claim 28, wherein the heat-sealing adhesive that is non-tacky at room temperature and suitable for applying the security element to a substrate of a document of value is obtainable by means of application of an aqueous dispersion.

30. The security element according to claim 28, wherein the heat-sealing adhesive that is non-tacky at room temperature and suitable for applying the security element to a substrate of a document of value is obtainable by means of application of a solution based on an organic solvent, the organic solvent comprising at least butyl acetate, propyl acetate or ethyl acetate, in a proportion by weight in a range from 30% to 90%.

31. The security element according to claim 30, wherein the heat-sealing adhesive additionally comprises a prepolymer that is non-tacky at room temperature after physical drying, contains on average at least two reactive groups and has a molecular weight of at least 600 g/mol in a proportion by weight in a range from 8% to 65%.

32. The security element according to claim 29, wherein the dispersion is selected from the group consisting of aliphatic polyurethane dispersions, aromatic polyurethane dispersions, acrylates, anionic acrylate-modified polyurethane dispersions, polyurethane-polyether acrylates, and mixtures of two or more of the aforementioned elements.

33. The security element according to claim 21, wherein the heat-sealing adhesive comprises a cationically radiation-curing resin.

34. The security element according to claim 21, wherein the radiation-crosslinkable component is crosslinkable by ultraviolet radiation or electron radiation.

35. The security element according to claim 21, wherein the heat-sealing adhesive contains a photoinitiator.

36. The security element according to claim 21, wherein the substrate is a transparent plastics film.

37. A document of value, in particular a banknote, comprising a security element according to claim 21.

38. A method for producing a security element according to claim 21, comprising the step of applying to a substrate a heat-sealing adhesive that is non-tacky at room temperature and suitable for applying the security element to a substrate of a document of value,
wherein the heat-sealing adhesive contains a radiation-crosslinkable component and a reactive diluent.

39. A method for producing a document of value according to claim 37, comprising the step of equipping the substrate of the document of value with the security element.

40. The method according to claim 39, wherein the security element is applied to the substrate of the document of value at elevated pressure and elevated temperature and the heat-sealing adhesive that is non-tacky at room temperature is then at least precrosslinked by means of radiation.
